(19) United States
(12) Patent Application Publication
(10) Pub. No.: US 2020/0107906 A1
(43) Pub. Date: Apr. 9, 2020

(54) TISSUE REMOVAL DEVICE

(71) Applicant: Mike Sabeti, Houston, TX (US)

(72) Inventor: Mike Sabeti, Houston, TX (US)

(21) Appl. No.: 16/578,225

(22) Filed: Sep. 20, 2019

(51) Int. Cl. A61C 3/02; A61C 5/42

(52) U.S. Cl. CPC A61C 3/02; A61C 5/42

(57) ABSTRACT

A surgical device including a tubular handle and a tissue removal member for removing target tissue, for example, granulation tissue, is provided. The tissue removal member extends from a distal end or from both a proximal end and the distal end of the tubular handle. The tissue removal member includes a shank, an arcuate section, a shaft of a configurable length for reaching a surgical site, and a loop receptacle. The loop receptacle extended from a distal end of the shaft. has an annular section defining an opening and a closed bottom end. The annular section includes a circular cutting edge for contacting and drawing away target tissue from the surgical site. The opening of the loop receptacle receives and holds the target tissue drawn away from the surgical site, thereby precluding the target tissue from being displaced during a removal of the target tissue.

### BACKGROUND

### Technical Field

The apparatus disclosed herein, in general, relates to a surgical instrument for removing tissue. More particularly, the apparatus disclosed herein relates to a tissue removal device for optimally holding and removing target tissue from a surgical site and precluding the target tissue from being displaced during surgery.

### Description of the Related Art

Many surgical procedures, for example, periodontal procedures, endodontic procedures, dental procedures for extraction sockets, etc., require a surgical removal of tissue, for example, granulation tissue, from a surgical site of operation. Granulation tissue refers to connective tissue with microscopic blood vessels that form on wound surfaces during a healing process. Under certain conditions such as an infection or a local reaction to a chronically implanted, foreign material, granulation tissue grows uncontrollably and becomes vascular and secretive. The presence of abundant granulation tissue may contribute to failure in the treatment of acute infections. The removal of damaged tissue or scar tissue is often required for preventing deterioration of associated or neighboring healthy tissue. For example, in the treatment of periodontal diseases such as periodontitis where granulation tissue is the diseased gingival tissue that is attached to the bone around the tooth, there is a need for removing the granulation tissue to arrest further deterioration of hard bony tissue and soft gingival tissue. The granulation tissue has a fibrous consistency and must be removed before the healthy gingival tissue and the bone can regenerate and reattach to the tooth.

Endodontic disorders refer to diseases or injuries that affect endodontic structures, for example, a root tip or a nerve of the tooth, a pulp chamber, pulp, and a root canal of the tooth. For example, a removal of irritant or diseased tissue associated with the root apex is needed in periradicular surgery to achieve optimal healing In some cases, after a tooth extraction, the granulation tissue that is formed in the extraction socket prevents the extraction socket from healing and leads to severe pain. Therefore, the removal of granulation tissue is required for proper healing in the treatment of extraction sockets and various diseases such as periodontal disease, endodontic disease, etc. Periapical periodontitis is an acute or chronic inflammatory lesion around the apex of a tooth root, which is typically caused by bacterial invasion of the pulp of the tooth. There is a need for a quick and complete removal of all granulation tissue for proper healing. An endodontic surgery is performed to remove the granulation tissue and a portion of a root with an infected space to treat this infection.

Conventionally, a curette is used for removing the granulation or scar tissue adjacent to a tooth. By continually scraping the granulation tissue with the curette, the sinewy tissue fibers are disconnected from the damaged bone and removed. The removal of the granulation tissue by a curette is a time consuming and tedious process, which can be stressful and frustrating for the patient as well as the surgeon depending upon the number of affected teeth. Moreover, during most surgical procedures in medical and dental practice, the tissue to be removed is often present in a location that is difficult to access. For example, in periodontal operations, the granulation tissue is recessed far below the gingival line, in areas of bone deterioration near the root of the tooth, thereby making it difficult to cut or scrape and remove the granulation tissue. Furthermore, tough fibrotic tissue that is bound to the underlying bone or tissue that is resistant to separation from a bony crypt is difficult to remove. Furthermore, when conventional tissue removal devices are used for removing granulation tissue, which is highly vascularized and therefore, bleeds profusely, the granulation tissue is typically displaced, making the granulation tissue difficult to remove and further making the process time consuming and tedious, which can be stressful and frustrating for the patient as well as the surgeon.

Hence, there is a long-felt need for a surgical device for optimally holding and removing target tissue from a surgical site and precluding the target tissue from being displaced during surgery. Furthermore, there is a need for a surgical device for removing tough fibrotic tissue that is positioned in a location that is difficult to access, or that is bound to the underlying bone, or that is resistant to separation from a bony crypt.

### SUMMARY

This summary is provided to introduce a selection of concepts in a simplified form that is further disclosed in the detailed description. This summary is not intended to determine the scope of the claimed subject matter.

The surgical device disclosed herein address the above-recited need for optimally holding and removing target tissue from a surgical site and precluding the target tissue from being displaced during surgery. For example, the surgical device disclosed herein is used for optimally holding and removing granulation tissue from an extraction socket and precluding the granulation tissue from being displaced during a periodontal surgery or an endodontic surgery. Furthermore, the surgical device disclosed herein removes tough fibrotic tissue that is positioned in a location that is difficult to access or that is bound to the underlying bone. The surgical device disclosed herein can also remove tissue that is resistant to separation from a bony crypt. The surgical device disclosed herein quickly and easily removes granulation tissue while maintaining a blood-free field during periodontal and endodontic surgical procedures. Since the granulation tissue is highly vascularized and therefore, bleeds profusely, the fast removal of the granulation tissue eliminates the source of bleeding quickly.

The surgical device disclosed herein comprises a tubular handle and a tissue removal member. The tubular handle comprises a proximal end and a distal end. The tissue removal member extends from the distal end of the tubular handle. In an embodiment, the tissue removal member extends from each of the distal end and the proximal end of the tubular handle. The tissue removal member comprises a shank, an arcuate section, a shaft of a configurable length, and a loop receptacle. The shank extends from the distal end of the tubular handle. The arcuate section extends from a distal end of the shank. The shaft extends from a distal end of the arcuate section for reaching a surgical site. The loop receptacle is positioned at a distal end of the shaft. The loop receptacle comprises an annular section, an opening defined by the annular section, and a closed bottom end. The annular section of the loop receptacle comprises a generally circular cutting edge for contacting and drawing away the target tissue from the surgical site. The opening of the loop receptacle receives and holds the target tissue drawn away from the surgical site, thereby precluding the target tissue from being displaced during the removal of the target tissue. The surgical device disclosed herein optimally removes the granulation tissue encountered, for example, in periodontal surgery, endodontic surgery and extraction sockets.

### BRIEF DESCRIPTION OF THE DRAWINGS

The foregoing summary, as well as the following detailed description, is better understood when read in conjunction with the appended drawings. For illustrating the apparatus and the method disclosed herein, exemplary constructions of the apparatus and the method are shown in the drawings. However, the apparatus and the method disclosed herein are not limited to the specific structures and methods disclosed herein. The description of a structure or a method step referenced by a numeral in a drawing is applicable to the description of that structure or method step shown by that same numeral in any subsequent drawing herein.

FIG. 1A exemplarily illustrates a top perspective view of a surgical device for removing target tissue and precluding the target tissue from being displaced during surgery.

FIG. 1B exemplarily illustrates a side elevation view of the surgical device for removing target tissue and precluding the target tissue from being displaced during surgery.

FIG. 1C exemplarily illustrates a bottom plan view of a surgical device for removing target tissue and precluding the target tissue from being displaced during surgery.

FIG. 1D exemplarily illustrates an enlarged view of a portion marked A in FIG. 1A, showing an arcuate section, a shaft, and a loop receptacle of a tissue removal member of the surgical device.

FIG. 2A exemplarily illustrates an enlarged perspective view of an embodiment of the loop receptacle.

FIG. 2B exemplarily illustrates an enlarged perspective view of the embodiment of the loop receptacle shown in FIG. 2A, showing removal of target tissue from a surgical site.

FIG. 3A exemplarily illustrates a bottom plan view of an embodiment of the surgical device for removing target tissue and precluding the target tissue from being displaced during surgery.

FIG. 3B exemplarily illustrates an enlarged view of a portion marked B in FIG. 3A, showing the arcuate section, the shaft, and the loop receptacle of the tissue removal member of the embodiment of the surgical device shown in FIG. 3A.

FIG. 4A exemplarily illustrates a top perspective view of another embodiment of the surgical device for removing target tissue and precluding the target tissue from being displaced during surgery.

FIG. 4B exemplarily illustrates a side elevation view of the embodiment of the surgical device shown in FIG. 4A.

FIG. 4C exemplarily illustrates a bottom plan view of the embodiment of the surgical device shown in FIG. 4A.

FIG. 4D exemplarily illustrates an enlarged view of a portion marked C in FIG. 4A, showing the arcuate section, the shaft, and the loop receptacle of the tissue removal member of the surgical device.

FIG. 5 illustrates a method for removing target tissue and precluding the target tissue from being displaced during surgery.

### DETAILED DESCRIPTION

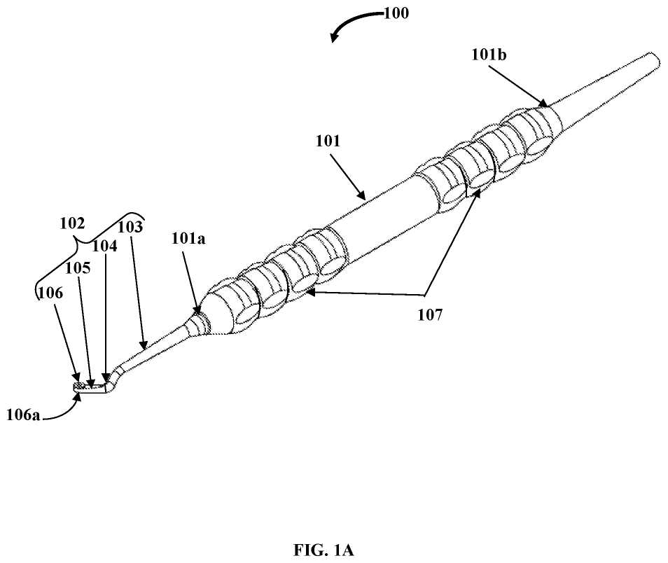

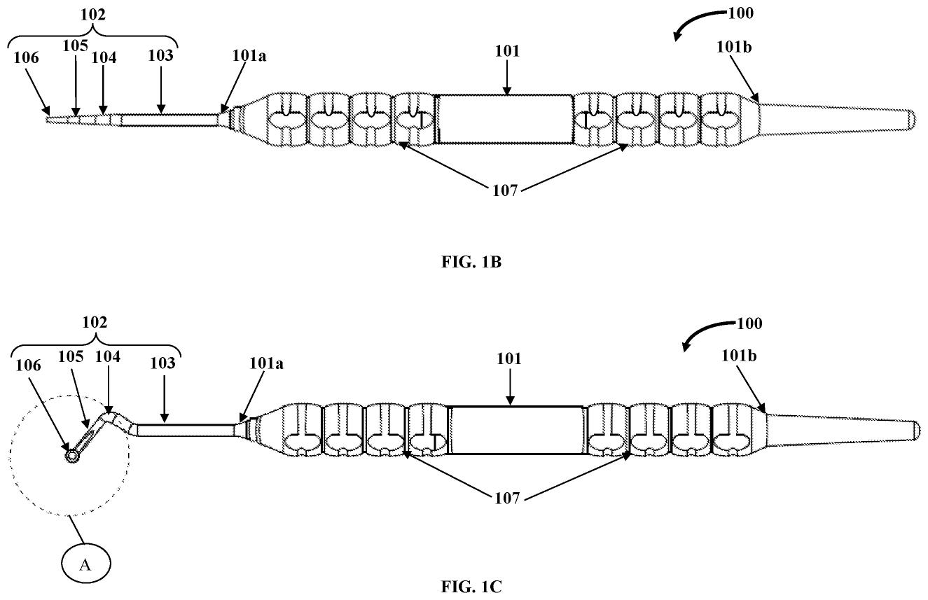

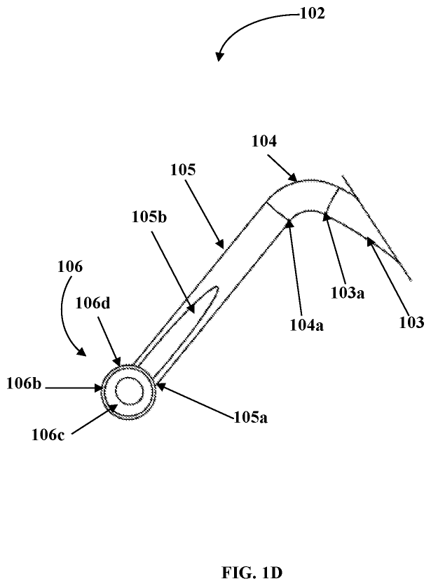

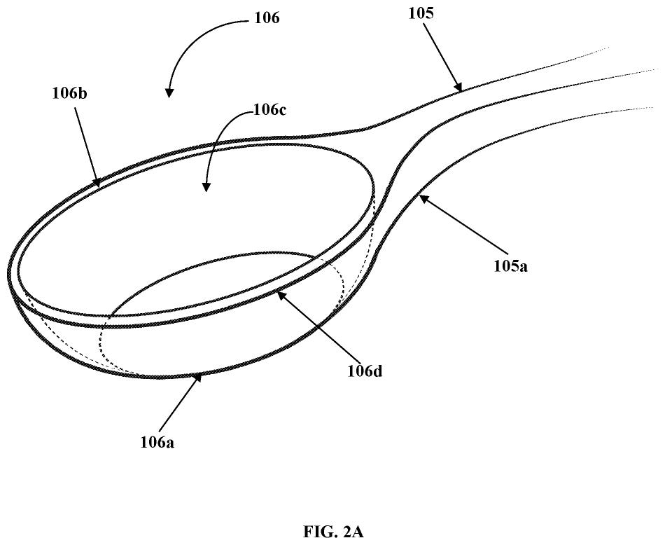

FIGS. 1A-1C exemplarily illustrate a top perspective view, a side elevation view, and a bottom plan view of a surgical device 100, also referred to as a “tissue removal device”, respectively, for removing target tissue and precluding the target tissue from being displaced during surgery. The target tissue comprises, for example, granulation tissue formed in wounds of dental structures comprising, for example, periodontal structures, endodontic structures, and extraction sockets. The surgical device 100 disclosed herein comprises a tubular handle 101 and a tissue removal member 102. The tubular handle 101 comprises a distal end 101a and a proximal end 101b as exemplarily illustrated in FIGS. 1A-1C. The tubular handle 101 is, for example, made of plastic. The tissue removal member 102 extends from the distal end 101a of the tubular handle 101. The tissue removal member 102 comprises a shank 103, an arcuate section 104, a shaft 105, and a loop receptacle 106 with a closed bottom end 106a. The shank 103 extends from the distal end 101a of the tubular handle 101. In an embodiment, the shank 103 tapers from the distal end 101a of the tubular handle 101. The arcuate section 104, the shaft 105, and the loop receptacle 106 of the tissue removal member 102 are disclosed in the detailed description of FIG. 1D. In an embodiment as exemplarily illustrated in FIGS. 1A-1C, the surgical device 100 disclosed herein further comprises one or more covering elements 107 surrounding the tubular handle 101 for allowing protective handling of the surgical device 100. The covering elements 107 are, for example, made of plastic. The surgical device 100 disclosed herein is made of metal, for example, steel, stainless steel, titanium, tungsten carbide, tantalum, platinum, palladium, etc.

FIG. 1D exemplarily illustrates an enlarged view of a portion marked A in FIG. 1A, showing the arcuate section 104, the shaft 105, and the loop receptacle 106 of the tissue removal member 102 of the surgical device 100. The arcuate section 104 extends from a distal end 103a of the shank 103. The shaft 105 of a configurable length extends from a distal end 104a of the arcuate section 104 for reaching a surgical site. The configurable length of the shaft 105 is, for example, between about 9.5 millimeters and about 14 millimeters. In an embodiment as exemplarily illustrated in FIGS. 1A-1D, the shaft 105 is configured with a short length of, for example, about 9.5 millimeters. The loop receptacle 106 is positioned at a distal end 105a of the shaft 105. The diameter of the loop receptacle 106 is, for example, between about 2 millimeters and about 4 millimeters. In an embodiment as exemplarily illustrated in FIGS. 1A-1D, the diameter of the loop receptacle 106 is, for example, about 2 millimeters.

The loop receptacle 106 of the tissue removal member 102 comprises an annular section 106b, an opening 106c defined by the annular section 106b, and the closed bottom end 106a. The thickness of the annular section 106b is, for example, between about 0.5 millimeters and 1 millimeter. The annular section 106b comprises a generally circular cutting edge 106d defined at the periphery of the annular section 106b. The generally circular cutting edge 106d is a sharp edge for contacting and drawing away the target tissue from the surgical site. The diameter of the opening 106c of the loop receptacle 106 is, for example, between about 1 millimeter and about 2 millimeters. In an embodiment as exemplarily illustrated in FIGS. 1A-1D, the diameter of the opening 106c of the loop receptacle 106 is, for example, about 1 millimeter.

The opening 106c of the loop receptacle 106 receives and holds the target tissue drawn away from the surgical site, thereby precluding the target tissue from being displaced during the removal of the target tissue. In an embodiment, the shaft 105 of the tissue removal member 102 comprises a cavity 105b of a configurable length in fluid communication with the opening 106c of the loop receptacle 106 for receiving and holding the target tissue drawn away from the opening 106c. As exemplarily illustrated in FIG. 1D, the cavity 105b of the shaft 105 is of an extended length. The loop receptacle 106, therefore, holds the target tissue and prevents the target tissue from moving away from the surgical device 100. The sharp configuration of the generally circular cutting edge 106d helps in removing the target tissue, for example, tough fibrotic tissue, from a bone crypt or tissue that is bound tough to the underlying bone, while the loop receptacle 106 helps in holding the target tissue during the removal of the target tissue, thereby precluding the target tissue from moving away or being displaced during surgery. The loop receptacle 106, therefore, allows a time-efficient removal of the target tissue from the surgical site and improves the experience of a patient as well as a surgeon performing the surgery.

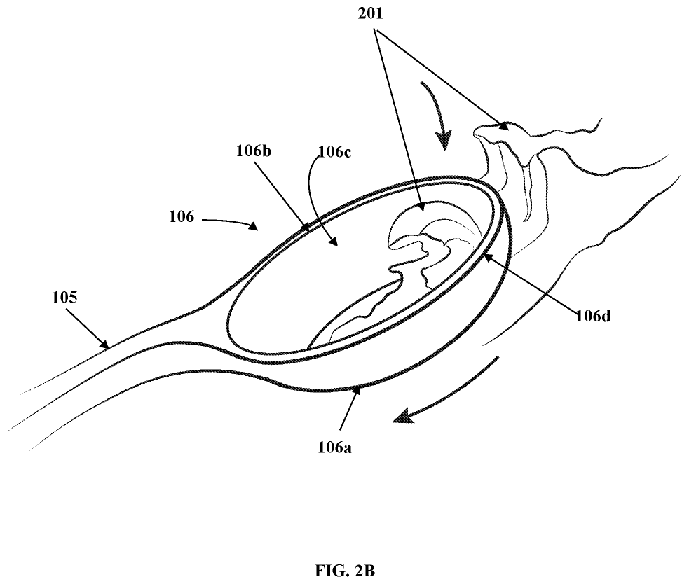

FIG. 2A exemplarily illustrates an enlarged perspective view of an embodiment of the loop receptacle 106. In this embodiment, the loop receptacle 106 is shaped, for example, like a spoon with a closed bottom end 106a. The spoon shaped loop receptacle 106 extends from the distal end 105a of the shaft 105.

FIG. 2B exemplarily illustrates an enlarged perspective view of the embodiment of the loop receptacle 106 shown in FIG. 2A, showing removal of target tissue 201 from a surgical site. As exemplarily illustrated in FIG. 2B, the generally circular cutting edge 106d of the loop receptacle 106 contacts and cuts the target tissue 201 from the surgical site, while the loop receptacle 106 receives and holds the cut target tissue 201 via the opening 106c of the loop receptacle 106. Since the granulation tissue 201 is highly vascularized and therefore, bleeds profusely, the fast removal of the granulation tissue 201 from the surgical site eliminates the source of bleeding quickly.

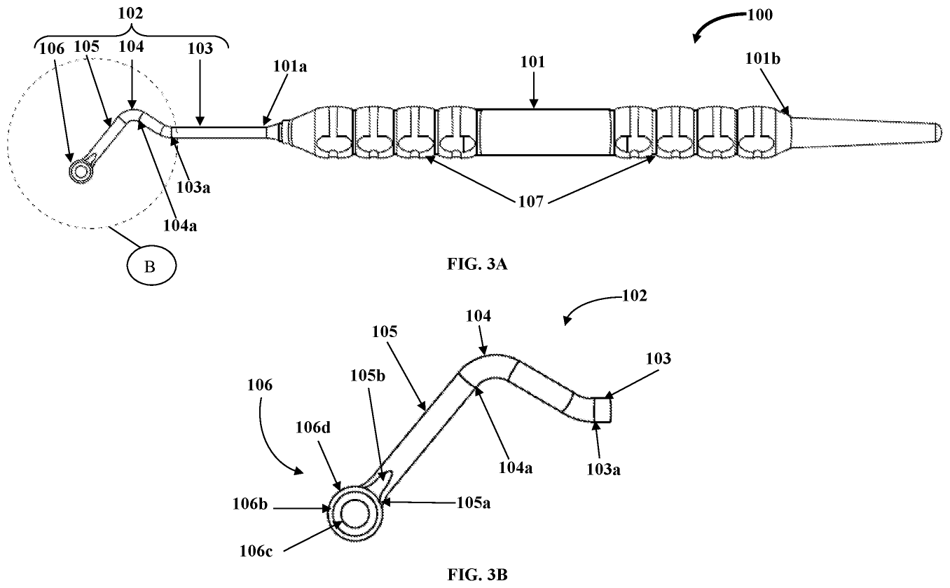

FIG. 3A exemplarily illustrates a bottom plan view of an embodiment of the surgical device 100 for removing target tissue and precluding the target tissue from being displaced during surgery. In the embodiment exemplarily illustrated in FIGS. 3A-3C, the surgical device 100 comprises the tubular handle 101 and the tissue removal member 102, where the tissue removal member 102 comprises the shank 103, the arcuate section 104, and the loop receptacle 106 as disclosed in the detailed description of FIGS. 1A-1D. In this embodiment, the tissue removal member 102 further comprises a shaft 105 configured with an extended length of, for example, about 14 millimeters, for reaching a surgical site that is difficult to access. For example, the surgical device 100 comprising the tissue removal member 102 having the shaft 105 configured with the extended length is used for reaching an extraction socket.

FIG. 3B exemplarily illustrates an enlarged view of a portion marked B in FIG. 3A, showing the arcuate section 104, the shaft 105, and the loop receptacle 106 of the tissue removal member 102 of the embodiment of the surgical device 100. In addition to the annular section 106b disclosed in the detailed description of FIG. 1D, the tissue removal member 102 further comprises an opening 106c defined by the annular section 106b of a larger diameter. In the embodiment exemplarily illustrated in FIGS. 3A-3B, the diameter of the opening 106c of the loop receptacle 106 is, for example, about 2 millimeters.

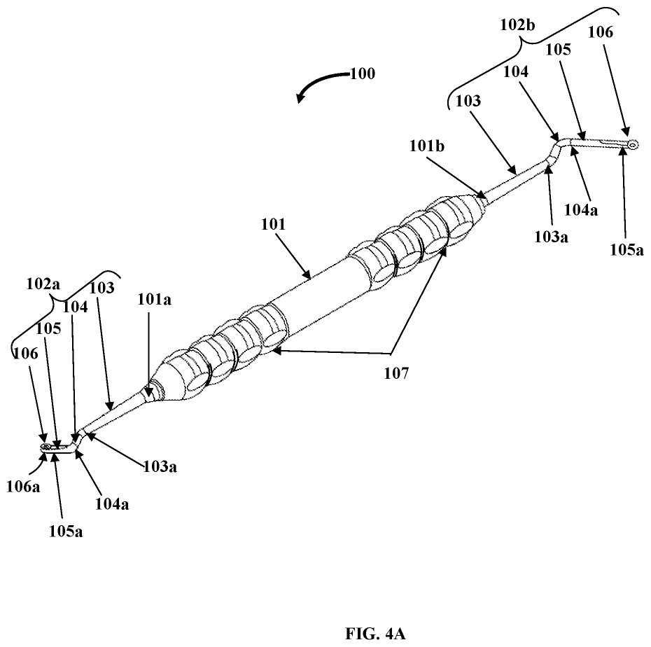

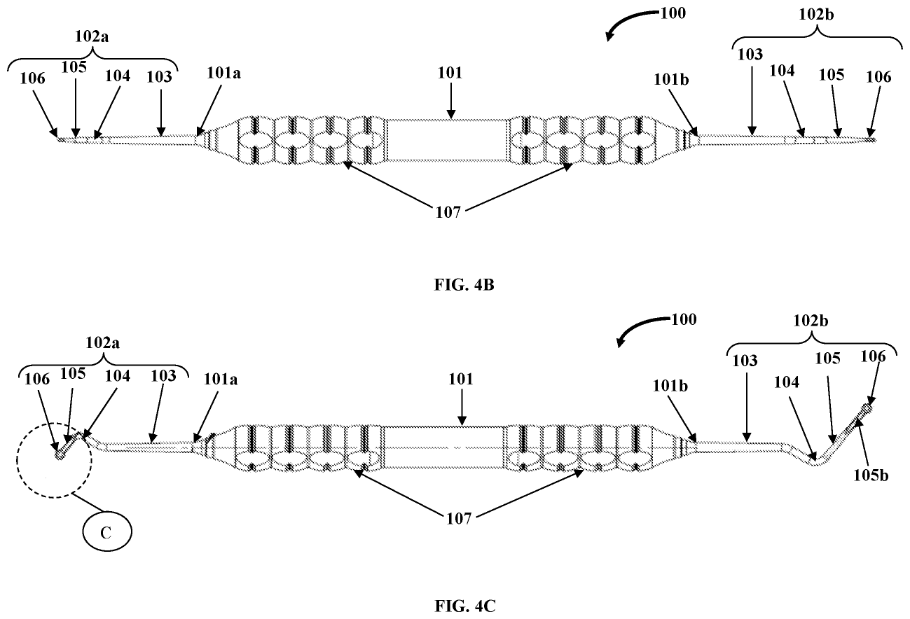

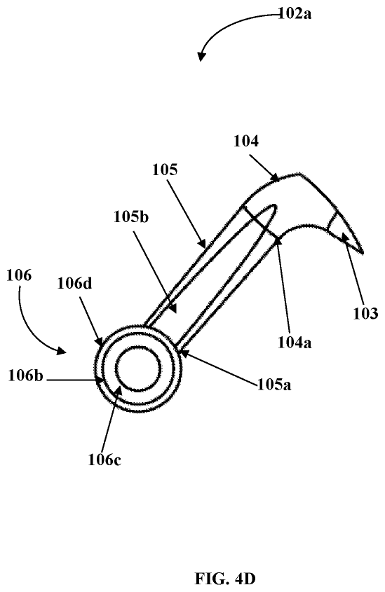

FIGS. 4A-4C exemplarily illustrate a top perspective view, a side elevation view, and a bottom plan view of another embodiment of the surgical device 100 respectively, for removing target tissue and precluding the target tissue from being displaced during surgery. In the embodiment exemplarily illustrated in FIGS. 4A-4C, the surgical device 100 comprises the tubular handle 101 and two tissue removal members 102a and 102b extending from the distal end 101a and the proximal end 101b of the tubular handle 101 respectively. In this embodiment, the length of the surgical device 100 is, for example, about 172 millimeters. Each of the tissue removal members 102a and 102b comprises a shank 103, an arcuate section 104, a shaft 105, and a loop receptacle 106 as disclosed in the detailed description of FIGS. 1A-1D and FIGS. 3A-3B. As exemplarily illustrated in FIGS. 4A-4C, a tissue removal member 102a with a shaft 105 of a short length of, for example, about 9.5 millimeters, extends from the distal end 101a of the tubular handle 101 as disclosed in the detailed description of FIG. 1B, and another tissue removal member 102b with a shaft 105 of an extended length of, for example, about 14 millimeters, as disclosed in the detailed description of FIG. 3B, extends from the proximal end 101b of the tubular handle 101.

FIG. 4D exemplarily illustrates an enlarged view of a portion marked C in FIG. 4A, showing the arcuate section 104, the shaft 105, and the loop receptacle 106 of the tissue removal member 102a positioned at the distal end 101a of the tubular handle 101 of the surgical device 100. The arcuate section 104, the shaft 105, and the loop receptacle 106 of the tissue removal member 102b positioned at the proximal end 101b of the tubular handle 101 of the surgical device 100 are exemplarily illustrated in FIG. 3B.

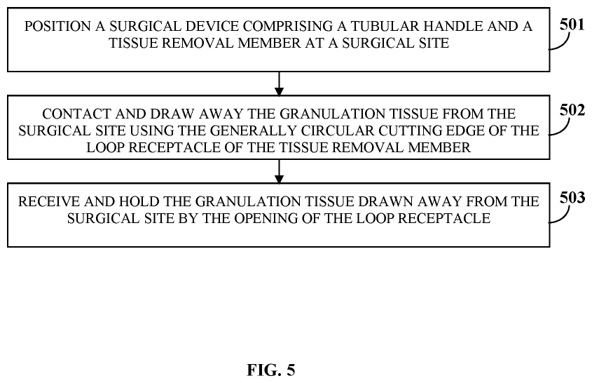

FIG. 5 illustrates a method for removing target tissue and precluding the target tissue, for example, granulation tissue, from being displaced during surgery. In the method disclosed herein, a surgeon positions 501 the surgical device 100 comprising the tubular handle 101 and the tissue removal member 102 exemplarily illustrated in FIGS. 1A-1D and FIGS. 3A-3B, at a surgical site, for example, an extraction socket. The shaft 105 of an extended length of, for example, about 14 millimeters, of the tissue removal member 102 exemplarily illustrated in FIG. 3B, allows the surgeon to reach the extraction socket that is difficult to access. The surgeon uses the generally circular cutting edge 106d of the loop receptacle 106 of the tissue removal member 102 exemplarily illustrated in FIG. 3B, to contact and draw away 502 the granulation tissue from the extraction socket. The surgeon grabs and cuts the granulation tissue from the extraction socket using the generally circular cutting edge 106d of the loop receptacle 106. The granulation tissue is drawn into the opening 106c of the loop receptacle 106 as exemplarily illustrated in FIG. 2B. The opening 106c of the loop receptacle 106 receives and holds 503 the granulation tissue drawn away from the extraction socket, thereby precluding the granulation tissue from being displaced during the removal of the granulation tissue. In an embodiment, the granulation tissue that is drawn into the opening 106c of the loop receptacle 106 is then drawn into the cavity 105b of the shaft 105 of the tissue removal member 102 exemplarily illustrated in FIG. 3B. The cavity 105b of the shaft 105 also receives and holds the granulation tissue drawn away from the extraction socket, thereby precluding the granulation tissue from being displaced during the removal of the granulation tissue.

Consider an example where a surgeon is required to perform periodontal surgery for treatment of a periodontal disease such as periodontitis where granulation tissue is attached to the bone around the tooth. The granulation tissue has a fibrous consistency and must be removed before the healthy gingival tissue and the bone can regenerate and reattach to the tooth. Furthermore, tough fibrotic granulation tissue bound to the underlying bone and the granulation tissue resistant to separation from a bony crypt must be removed. The surgeon uses the surgical device 100 exemplarily illustrated in FIGS. 1A-1D, for removing the granulation tissue in a time-efficient and optimal manner. The surgeon grasps the tubular handle 101 of the surgical device 100 exemplarily illustrated in FIGS. 1A-1C, and uses the generally circular cutting edge 106d of the loop receptacle 106 of the tissue removal member 102 exemplarily illustrated in FIG. 3B, to contact and draw away the tough fibrotic granulation tissue bound to the underlying bone and the granulation tissue from the bony crypt. The surgeon grabs and cuts the tough fibrotic granulation tissue bound to the underlying bone and the bony crypt using the generally circular cutting edge 106d of the loop receptacle 106 of the tissue removal member 102. The cut granulation tissue is drawn into the opening 106c of the loop receptacle 106. The opening 106c of the loop receptacle 106 receives and holds the granulation tissue drawn away from the underlying bone and the bony crypt, thereby precluding the granulation tissue from being displaced during the removal of the granulation tissue. The surgeon then retracts the surgical device 100 containing the granulation tissue contained in the loop receptacle 106 of the tissue removal member 102 from the surgical site. Since the granulation tissue is not displaced during the periodontal surgery, the surgeon saves time and optimally completes the periodontal surgery.

The foregoing examples have been provided merely for explanation and are in no way to be construed as limiting of the surgical device 100 disclosed herein. While the surgical device 100 has been described with reference to various embodiments, it is understood that the words, which have been used herein, are words of description and illustration, rather than words of limitation. Furthermore, although the surgical device 100 has been described herein with reference to particular means, materials, and embodiments, the surgical device 100 is not intended to be limited to the particulars disclosed herein; rather, the surgical device 100 extends to all functionally equivalent structures, methods, and uses, such as are within the scope of the appended claims. While multiple embodiments are disclosed, it will be understood by those skilled in the art, having the benefit of the teachings of this specification, that the surgical device 100 disclosed herein is capable of modifications and other embodiments may be effected and changes may be made thereto, without departing from the scope and spirit of the surgical device 100 disclosed herein.

What is claimed is:

1. A surgical device for removing target tissue and precluding said target tissue from being displaced during surgery, said surgical device comprising:
a tubular handle comprising a proximal end and a distal end; and
a tissue removal member extending from said distal end of said tubular handle, said tissue removal member comprising:
a shank extending from said distal end of said tubular handle;
an arcuate section extending from a distal end of said shank;
a shaft of a configurable length extending from a distal end of said arcuate section for reaching a surgical site; and
a loop receptacle positioned at a distal end of said shaft, said loop receptacle comprising an annular section, an opening defined by said annular section, and a closed bottom end, wherein said annular section comprises a generally circular cutting edge for contacting and drawing away said target tissue from said surgical site, and wherein said opening of said loop receptacle receives and holds said target tissue drawn away from said surgical site, thereby precluding said target tissue from being displaced during a removal of said target tissue.

2. The surgical device according to claim 1, wherein said shaft of said tissue removal member comprises a cavity of a configurable length in fluid communication with said opening of said loop receptacle for receiving and holding said target tissue drawn away from said opening.

3. The surgical device according to claim 1, further comprising one or more covering elements surrounding said tubular handle for allowing protective handling of said surgical device.

4. The surgical device according to claim 1, wherein said tissue removal member extends from each of said distal end and said proximal end of said tubular handle.

5. The surgical device according to claim 1, wherein said configurable length of said shaft of said tissue removal member is between about 9.5 millimeters and about 14 millimeters.

6. The surgical device according to claim 1, wherein a diameter of said loop receptacle of said tissue removal member is between about 2 millimeters and about 4 millimeters.

7. The surgical device according to claim 1, wherein a diameter of said opening of said loop receptacle of said tissue removal member is between about 1 millimeter and about 2 millimeters.

8. The surgical device according to claim 1, wherein said target tissue comprises granulation tissue formed in wounds of dental structures.

9. The surgical device according to claim 8, wherein said dental structures comprise periodontal structures, endodontic structures, and extraction sockets.

10. A surgical device for removing target tissue and precluding said target tissue from being displaced during surgery, said surgical device comprising:
a tubular handle comprising a proximal end and a distal end; and
a tissue removal member extending from each of said distal end and said proximal end of said tubular handle, said tissue removal member comprising:
a shank extending from said distal end of said tubular handle;
an arcuate section extending from a distal end of said shank;
a shaft of a configurable length extending from a distal end of said arcuate section for reaching a surgical site; and
a loop receptacle positioned at a distal end of said shaft, said loop receptacle comprising an annular section, an opening defined by said annular section, and a closed bottom end, wherein said annular section comprises a generally circular cutting edge for contacting and drawing away said target tissue from said surgical site, and wherein said opening of said loop receptacle receives and holds said target tissue drawn away from said surgical site, thereby precluding said target tissue from being displaced during a removal of said target tissue.

11. The surgical device of claim 10, wherein said shaft of said tissue removal member comprises a cavity of a configurable length in fluid communication with said opening of said loop receptacle for receiving and holding said target tissue drawn away from said opening.

12. The surgical device of claim 10, further comprising one or more covering elements surrounding said tubular handle for allowing protective handling of said surgical device.

13. The surgical device of claim 10, wherein said configurable length of said shaft of said tissue removal member is between about 9.5 millimeters and about 14 millimeters.

14. The surgical device of claim 10, wherein a diameter of said loop receptacle of said tissue removal member is between about 2 millimeters and about 4 millimeters.

15. The surgical device of claim 10, wherein a diameter of said opening of said loop receptacle of said tissue removal member is between about 1 millimeter and about 2 millimeters.

16. The surgical device of claim 10, wherein said target tissue comprises granulation tissue formed in wounds of dental structures.

17. The surgical device of claim 16, wherein said dental structures comprise periodontal structures, endodontic structures, and extraction sockets.

18. A method for removing target tissue and precluding said target tissue from being displaced during surgery, said method comprising:
positioning a surgical device at a surgical site, said surgical device comprising:
a tubular handle comprising a proximal end and a distal end; and
a tissue removal member extending from said distal end of said tubular handle, said tissue removal member comprising:
a shank extending from said distal end of said tubular handle;
an arcuate section extending from a distal end of said shank;
a shaft of a configurable length extending from a distal end of said arcuate section for reaching a surgical site; and
a loop receptacle positioned at a distal end of said shaft, said loop receptacle comprising an annular section with a generally circular cutting edge, an opening defined by said annular section, and a closed bottom end;
contacting and drawing away said target tissue from said surgical site using said generally circular cutting edge of said loop receptacle of said tissue removal member of said surgical device; and
receiving and holding said target tissue drawn away from said surgical site by said opening of said loop receptacle, thereby precluding said target tissue from being displaced during a removal of said target tissue.

19. The method of claim 18, wherein said shaft of said tissue removal member of said surgical device comprises a cavity of a configurable length in fluid communication with said opening of said loop receptacle for receiving and holding said target tissue drawn away from said opening.

20. The method of claim 18, wherein said target tissue comprises granulation tissue formed in wounds of dental structures, and wherein said dental structures comprise periodontal structures, endodontic structures, and extraction sockets.
